(19) United States
(12) Patent Application Publication
(10) Pub. No.: US 2025/0279917 A1
(43) Pub. Date: Sep. 4, 2025

(54) SERDES-SPECIFIC GROUPS OF PAM-MODULATED SYMBOLS

(71) Applicant: Microchip Technology Incorporated, Chandler, AZ (US)

(72) Inventor: Peter Graumann, Calgary (CA)

(21) Appl. No.: 19/070,424

(22) Filed: Mar. 4, 2025

Related U.S. Application Data
(60) Provisional application No. 63/561,153, filed on Mar. 4, 2024.

(51) Int. Cl. H04L 25/49; H04L 25/03

(52) U.S. Cl. CPC H04L 25/4917; H04L 25/03057

(57) ABSTRACT

A method may include receiving eight bits of information; determining a state transition of a convolutional trellis at least partially based on a two-bit portion of the eight bits of information; determining a group of PAM-modulated symbols at least partially based on the determined state transition of the convolutional trellis, the eight bits of information, and a set of predetermined groups of PAM-modulated symbols pre-associated with the determined state transition of the convolutional trellis; and encoding the eight bits of information into the determined group of PAM-modulated symbols.

### CROSS-REFERENCE TO RELATED APPLICATIONS

This application claims the benefit under 35 U.S.C. § 119 (e) of U.S. Provisional Patent Application Ser. No. 63/561,153, filed Mar. 4, 2024, the disclosure of which is hereby incorporated herein in its entirety by this reference.

### FIELD

Examples relate to signal processing and decoding signals encoding using quinary signaling techniques. Some examples relate to choosing symbol groups used for pulse amplitude modulation (PAM) modulated signaling (e.g., PAM4, PAM5, PAM6, PAM8, and variants thereof, without limitation).

### BACKGROUND

Various signaling techniques are used in normal and high-speed serial communication systems. Examples include binary signaling techniques such as Pulse Amplitude Modulation 2 (PAM2), signaling techniques that use higher numbers of levels, such as PAM4, PAM5, PAM6, PAM8, and variants thereof.

### BRIEF DESCRIPTION OF THE DRAWINGS

To easily identify the discussion of any particular element or act, the most significant digit or digits in a reference number refer to the figure number in which that element is first introduced. The patent or application file contains at least one drawing executed in color. Copies of this patent or patent application publication with color drawing(s) will be provided by the Office upon request and payment of the necessary fee.

FIG. 1 illustrates an example process to generate a set of signal-level patterns (a “symbol alphabet”) for mapping digital data into PAM-modulated signals in high-speed SerDes environments, in accordance with one or more examples.

FIG. 2 is a block diagram illustrating a convolutional encoder (sometimes referred to as a “Trellis Coded Modulation (TCM) encoder 200”), in accordance with one or more examples.

FIG. 3 illustrates an example process for encoding an eight-bit input word into a group of PAM-modulated symbols using a convolutional trellis, in accordance with one or more examples.

FIG. 4 illustrates an example process to select a group of PAM-modulated symbols to represent eight bits of information, in accordance with one or more examples.

FIG. 5 is an example of four consecutive symbols S0, S1, S2 and S3 of a symbol group on differential pair of a high-speed SerDes.

FIG. 6 is a block diagram depicting convolutional encoder to implement a PAM8 modulation scheme, which may be utilized in high-speed SerDes systems, such as 448G applications, in accordance with one or more examples.

FIG. 7 depicts s a convolutional encoder to implement PAM8 modulation, suitable for high-speed communication applications such as 448G SerDes links, in accordance with one or more examples.

FIG. 8 a graph depicting non-limiting example comparative performance analysis of different pulse amplitude modulation (PAM) encoding techniques and receiver structures, specifically highlighting the effectiveness of the disclosed convolutional trellis encoding and optimized symbol selection techniques for PAM-modulated signals in high-speed SerDes applications.

FIG. 9 is a block diagram depicting a system (or apparatus) for high-speed data transmission in accordance with one or more examples.

FIG. 10 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths, and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer, including a processor, is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description the term “coupled,” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

A convolutional coder is a finite state machine (FSM) with a limited amount of state. A convolutional coder produces output bits that are various functions of input bits and the state. After the output bits are produced, the FSM transitions to a new state based on the input bits and the previous state. A decoder considers a received sequence of bits and determines an input sequence of bits that best (most likely) explains the received sequence of bits (stated another way, determines the input sequence of bits that most likely produced the received sequence of bits).

A trellis is a graphical representation of the FSM of the convolutional coder that illustrates the state transitions of the convolutional coder over time. The trellis includes a first set of nodes (depicted as circles) that represent possible states at a current time step, a second set of nodes that represent possible states at a next time step, and arcs (depicted as arrows) that connect nodes in the first set to nodes in the second set. Each node represents a specific state (e.g., identified by a number). Each arc represents a valid transition from one state to another state. Using a trellis representative of the convolutional coder, a decoder only has to consider the finite number of possible states, and the most likely sequence that led to that state, using an algorithm such as the Viterbi algorithm.

A convolutional coder can be used by a transmitter to produce encoded output bits that are a function of a current input bit and one or more previous input bits that set the coder's current state. This effectively spreads the information of an input bit (the current input bit) over several output bits, which increases redundancy and the ability of a receiver to detect and correct errors that may occur during transmission. The redundancy introduced by convolutional encoding allows a transmitted signal to be more resilient to the impairments of the channel, such as noise, insertion loss, and interference. The encoded output bits may be modulated onto a carrier using a modulation scheme, i.e., encoded output bits are mapped to physical symbols that are transmitted on a physical medium (the transmitted symbols).

Trellis-Coded Modulation (TCM) is a modulation technique for producing a transmitted sequence of symbols by integrating convolutional encoding with modulation. A symbol group is produced that is mapped based on an input sequence of bits and the state of a convolutional coder. The state of the convolutional coder transitions to a new state based on the previous state and some or a totality of the bits of the input sequence of bits. A logical or functional block that performs TCM may also be referred to herein as a “convolutional trellis.”

Pulse amplitude modulation (PAM) is a modulation technique that encodes data by varying amplitude of electrical pulses using multiple distinct signal levels. Various PAM modulation schemes may utilize different numbers of discrete signal levels (e.g., PAM4, PAM5, PAM6, PAM8, and variants thereof, without limitation), each scheme capable of representing a different number of information bits per symbol.

Using PAM5 as a non-limiting example, in PAM5 (Pulse Amplitude Modulation with 5 levels), five distinct voltage levels are used to represent symbols, and each symbol represents 2 bits of data. As a non-limiting example, the five voltage levels in PAM5 may be represented by −2, −1, 0, +1, and +2 volts (or −1, −½, 0, +½, +1 volts). In practice, different voltage levels than these may be utilized depending on specific operating conditions, such as specific channel characteristics, without limitation.

As a non-limiting example, in standard PAM5 modulation, each individual PAM5 symbol inherently carries about 2.32 bits of information (log₂5˜2.32). Modern systems, particularly those employing Trellis Coded Modulation (TCM) or similar advanced encoding techniques, map PAM-modulated symbols to 2 bits of information, with the extra level providing additional design margin or redundancy for error correction. Further, such systems may group multiple PAM-modulated symbols together. By doing so, information is spread across several PAM-modulated symbols, which allows for the representation of more bits per group and also provides redundancy that improves error correction.

For example, a sequence of four PAM-modulated symbols (sometimes called a “group of PAM5 symbol” or a “PAM5 symbol group”), each with five signal levels, can produce 5⁴=625 unique signal-level patterns. When encoding 9 bits of information, 512 of these 625 patterns may be chosen (leaving some unused) to map each 9-bit value to a unique sequence of four PAM-modulated symbols. Similarly, when encoding 8 bits of information, 256 of the 625 signal-level patterns may be chosen (leaving some unused) to map each 8-bit value onto a unique sequence of four PAM-modulated symbols.

High-speed SerDes channels typically encounter significant impairments such as insertion loss, noise, inter-symbol interference (ISI), and non-ideal decision feedback equalizer (DFE) behavior/DFE-induced errors, all of which can hinder achievement of stringent symbol error rate (SER) targets (e.g., 1×10⁻⁶ or lower, without limitation) with traditional approaches to PAM modulation schemes (e.g., PAM4, PAM5, PAM6, PAM8, and variants thereof, without limitation). These impairments reduce transmission reach, increase power consumption, and necessitate complex receiver architectures, thereby limiting system performance and reliability.

PAM modulation supports multiple signal levels per symbol, which translates to multiple bits per symbol (e.g., log₂5˜2.32 bits for PAM5, without limitation). Typically, practical implementations map each PAM symbol to an integer number of bits (e.g., 2 bits per PAM5 symbol, without limitation), utilizing the additional levels for redundancy and error-correction purposes. To further enhance performance, modern systems group multiple PAM symbols together, thereby spreading the encoded information across several symbols. This enables redundancy and error correction at a group-level rather than an individual symbol level.

For example, as discussed above, a sequence of four PAM-modulated symbols (“PAM5 symbol group”) provides 625 unique signal-level patterns (5⁴=625). When encoding 9 bits of information, 512 of these patterns may be selected, leaving surplus patterns unused to enhance error resilience and coding flexibility. Similarly, encoding 8 bits of information involves selecting 256 of the available 625 patterns, providing even greater flexibility and margin for error mitigation.

Specific signal-level patterns used as PAM-modulated symbol groups affect the SER differently based on operating conditions such as type of electronic communication system, channel characteristics, and transmission medium characteristics. For example, the SER when using a given alphabet, transition group, or symbol group with, as a non-limiting example, a 1000Base-T communication system (“1000Base-T”) may be vastly different than the SER when using the given alphabet, transition group, or symbol group with, as a non-limiting example, a high-speed SerDes communication system (“high-speed SerDes”). Further, sometimes a DFE is used to mitigate inter-symbol interference by using previous symbol decisions to cancel out their effects on the current symbol. However, if an error occurs in the DFE, that error can propagate to subsequent symbols, worsening the overall performance.

The inventor of this disclosure appreciates that the choice of specific symbol patterns significantly impacts SER performance. Choosing a subset of these patterns that ensures DC balance, minimal power consumption, sufficient distance (e.g., trellis distance such as Euclidean distance, Hamming distance, without limitation) between patterns, and resistance to DFE-induced errors is a significant design challenge. Integrating a convolutional trellis encoder with a high-speed SerDes-specific PAM-modulated symbol alphabet (e.g., PAM4, PAM5, PAM6, PAM8, and variants thereof, without limitation) and dedicated transition groups, thereby increasing coding gain, improving SER, and enhancing overall data integrity under challenging channel conditions. The symbol error rate (SER) is the ratio of the number of symbols received incorrectly to the total number of symbols sent over a given period. “Error” means a received symbol recovered by a decoder is different than the originally transmitted symbol.

Examples discussed herein integrate a convolutional trellis encoder with a PAM-modulated symbol alphabet specifically optimized for high-speed SerDes channels. Such integration leverages a predetermined symbol alphabet and predetermined symbol groups tailored to specific trellis state transitions, accounting explicitly for high-speed SerDes channel characteristics.

By associating particular PAM symbol groups with specific transitions between trellis states, these examples improve coding gain, reduce SER, and enhance resilience against DFE-induced error propagation. Specifically, assigning tailored symbol groups to state transitions mitigates large voltage swings, isolates errors, and enhances overall decoding robustness, significantly improving the data integrity and performance of high-speed SerDes communication systems.

One or more examples relate, generally, to choosing a symbol alphabet for PAM modulation (e.g., PAM4, PAM5, PAM6, PAM8, and variants thereof, without limitation) optimized for use by a convolutional trellis based on channel-specific characteristics—such as those found in high-speed SerDes environments—which differ notably from other communication systems, for example, 1000Base-T.

Further, one or more examples relate to associating specific groups of PAM symbols with specific transitions between states of a convolutional trellis and employing these symbol groups during PAM modulation encoding. In a trellis-coded modulation (TCM) system, the trellis is a finite state machine where each state represents memory of previous input bits. High-speed SerDes systems utilize decision feedback equalization (DFE) to mitigate inter-symbol interference by subtracting previously decoded symbols from the current symbol. However, an error in the DFE process can propagate into subsequent symbols, negatively impacting performance. Examples described herein may reduce the effects of DFE error propagation by assigning tailored groups of PAM symbols to each state transition of the convolutional trellis. These tailored symbol groups are chosen to exhibit desirable characteristics such as increased symbol distance (e.g., trellis distance such as Euclidean distance or Hamming distance, without limitation) and controlled voltage swings, thus ensuring that symbol patterns remain distinguishable despite potential DFE errors. Additionally, the separation of symbol groups assigned to different state transitions (reducing overlap among symbols and/or symbol groups) further isolates error propagation, enhancing decoding robustness.

Further, providing a surplus of signal-level patterns beyond those strictly required to represent all N-bit combinations (e.g., more than 512 signal-level patterns for 9-bit encoding or more than 256 signal-level patterns for 8-bit encoding, without limitation) allows support for multiple, non-overlapping subsets of PAM symbol groups. Each subset can represent a suitable number of unique signal-level patterns while minimizing overlap between subsets assigned to distinct trellis transitions. This deliberate separation improves convolutional trellis coding performance (e.g., increased coding strength, without limitation) by ensuring clear differentiation between transitions, thereby reducing errors, and enhancing data integrity.

As a non-limiting example, in the case of four-symbol PAM5 groups, at least eight subsets of symbol groups may be assigned to specific convolutional trellis transitions, with each subset containing 64 unique signal-level patterns. In practice, assignment methods may strategically minimize overlap between subsets, thereby optimizing overall system performance.

### High-Speed SerDes-Specific Symbol Alphabet Generation

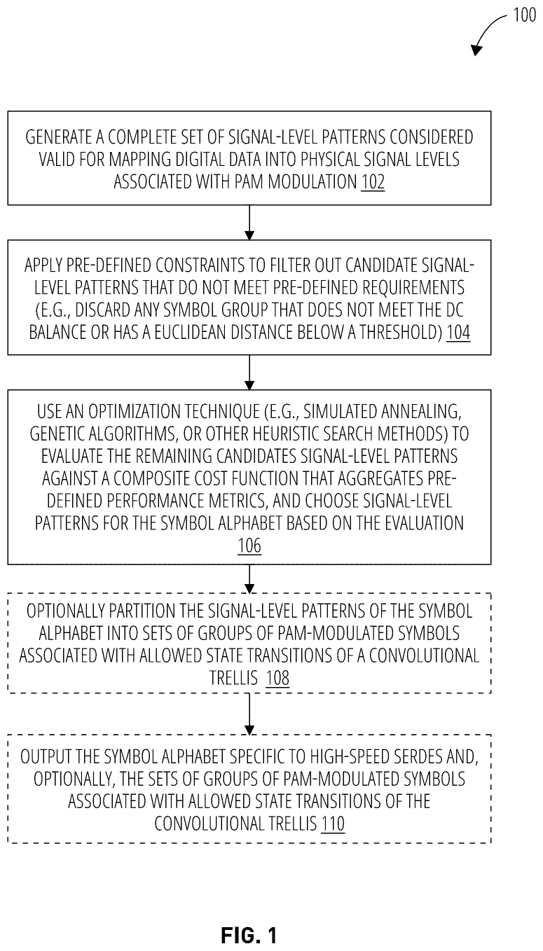

FIG. 1 illustrates an example process 100 to generate a set of signal-level patterns (a “symbol alphabet”) for mapping digital data into PAM-modulated signals in high-speed SerDes environments, in accordance with one or more examples. Although the example process 100 depicts a particular sequence of operations, the sequence may be altered without departing from the scope of the present disclosure. For example, some of the operations depicted may be performed in parallel or in a different sequence that does not materially affect the function of the process 100. In other examples, different components of an example device or system that implements the process 100 may perform functions at substantially the same time or in a specific sequence.

According to one or more examples, process 100 may include generating a complete set of signal-level patterns considered valid for mapping digital data into physical signal levels associated with PAM modulation at block 102. Generating this complete set involves enumerating all possible combinations of the available PAM-modulated signal levels for a given length of symbol group. As a non-limiting example, for PAM5 modulation, if a symbol group consists of four symbols and each symbol can assume one of five distinct levels (e.g., −2, −1, 0, +1, +2), the complete set is the Cartesian product of the five levels taken four times, resulting mathematically in 5⁴=625 unique patterns. Gathering the full universe of potential patterns ensures that no viable candidate is excluded prematurely, allowing process 100 to choose an optimized subset tailored specifically to the channel, as discussed below.

According to one or more examples, process 100 may include applying pre-defined constraints to filter out candidate signal-level patterns that do not meet pre-defined requirements (e.g., discard any symbol group that does not meet the DC balance or has a distance (e.g., Euclidian distance, Hamming distance, without limitation) below a threshold, without limitation) at block 104. This ensures that only patterns with baseline suitability for high-speed SerDes channels remain.

In the case of a DC balance check, the algorithm examines each candidate group of PAM-modulated symbols to determine its DC offset—for example, by averaging the amplitude values of the symbols in the group. If the average deviates from zero by more than a specified threshold, the candidate is discarded. This ensures that only groups with a balanced DC level, which is critical for minimizing baseline wander in high-speed channels, are retained.

In the case of a Euclidian distance check, the algorithm determines the Euclidean distance between each candidate pattern and its nearest neighbor (or among all pairs, depending on the design). If the minimum distance for a candidate pattern is below a pre-determined threshold, it is rejected. This helps ensure that the remaining patterns are sufficiently spaced apart in the signal space, thereby enhancing noise immunity and reducing the likelihood of symbol errors.

According to one or more examples, process 100 may include using an optimization technique (e.g., simulated annealing, genetic algorithms, or other heuristic search methods) to evaluate the remaining candidates signal-level patterns against a composite cost function that aggregates pre-defined performance metrics, and choose signal-level patterns for the symbol alphabet based on the evaluation at block 106. By combining multiple design objectives into a single cost function, block 106 yields an alphabet that balances conflicting requirements-like increasing distance between patterns while minimizing transmit power.

For example, after candidate signal-level patterns are filtered by the constraints at block 104, the algorithm may form a composite cost function that quantifies how well each signal-level pattern (or set of patterns) meets the desired performance objectives. These objectives might include: a Euclidean distance check to ensure patterns are sufficiently spaced apart for robust error correction; DC balance check to ensure that the average level of the symbols remains near zero; and a power consumption check to minimize the average energy or power required to transmit the pattern. A mathematical expression is formulated that assigns a cost (or “penalty”) to each candidate pattern (or set of patterns) based on deviations from the target values for each performance metric. An optimization algorithm such as simulated annealing or a genetic algorithm is executed to evaluate sets of candidate signal-level patterns against the cost function, and it anneals toward a set that suitably balances the objectives.

According to one or more examples, process 100 may include optional partition the signal-level patterns of the symbol alphabet into sets of groups of PAM-modulated symbols associated with allowed state transitions of a convolutional trellis at block 108. Organizing patterns into discrete subsets can enhance error correction by ensuring each state transition in a convolutional trellis has a dedicated set of patterns tailored for that transition's requirements. Once the algorithm converges or meets a stopping criterion (such as a maximum number of iterations or a minimal cost threshold), the resultant set of signal-level patterns is output as the high-speed SerDes-specific symbol alphabet.

### Optional: Determine Transition Groups

According to some examples, process 100 may include outputting the symbol alphabet specific to high-speed SerDes and, optionally, the sets of groups of PAM-modulated symbols associated with allowed state transitions of the convolutional trellis at block 110. This makes the chosen patterns available for encoding data, ensuring that subsequent mapping and trellis operations can leverage the performance benefits identified in other blocks of process 100.

For example, once the optimization algorithm (e.g., simulated annealing or a genetic algorithm) has identified the best subset of signal-level patterns, these patterns are loaded into a lookup table stored in non-volatile memory, ROM, or RAM. This table contains the high-speed SerDes-specific symbol alphabet. If the optimized alphabet is partitioned into distinct sets corresponding to allowed state transitions (i.e., transition groups), these sets are stored as separate arrays or segmented entries within the lookup table. Each segment is linked to a specific state transition in the convolutional trellis. When a transmitter later processes digital data, its mapping logic retrieves the corresponding symbol group from the lookup table based on the current trellis state and input bits. This ensures that the mapping and trellis operations leverage the performance benefits (e.g., high Euclidean distance, DC balance) identified during the optimization process.

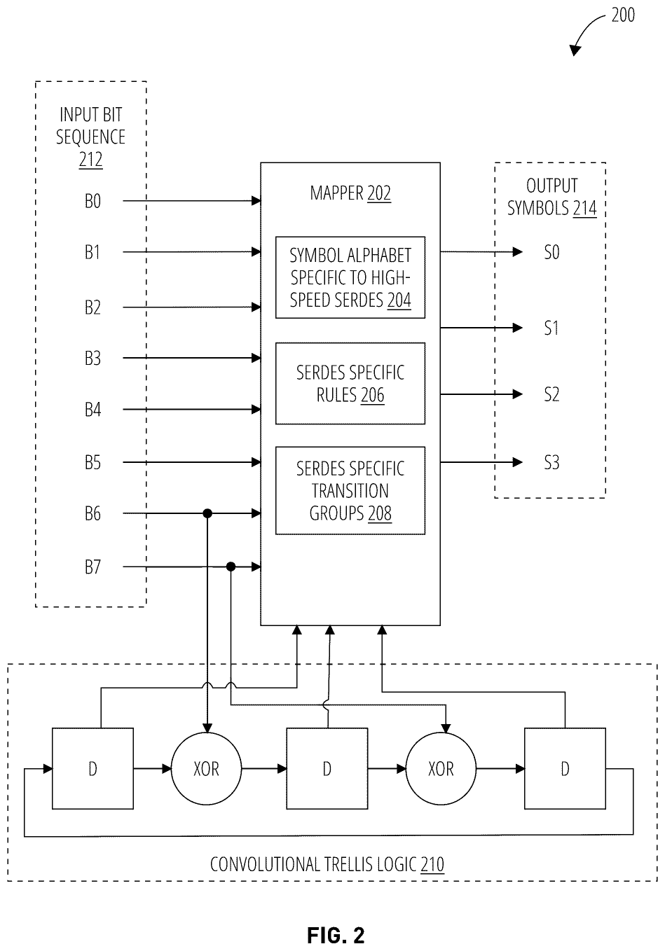

Having described, in FIG. 1, an example process for generating a high-speed SerDes-specific symbol alphabet optimized for channel constraints, FIG. 2 illustrates how a symbol alphabet and transition groups are employed within an example convolutional encoder 200 to transform an input bit sequence 212 into an output symbols 214 of a group of PAM-modulated symbols. More specifically, the convolutional trellis logic 210 introduces memory and coding redundancy, while a mapper 202 references the previously determined symbol alphabet, SerDes-specific rules 206, and SerDes-specific transition groups 208 to select an appropriate four-symbol PAM-modulated pattern (S0-S3). By integrating these functional elements, convolutional encoder 200 leverages the performance benefits identified in FIG. 1's optimization process—ensuring robust, low-error operation in high-speed SerDes channels.

FIG. 2 is a block diagram illustrating a convolutional encoder 200 (sometimes referred to as a “Trellis Coded Modulation (TCM) encoder 200”), in accordance with one or more examples. Convolutional encoder 200 is capable of converting an input bit sequence into a group of PAM-modulated symbols for transmission over a high-speed SerDes link, as discussed below. FIG. 2 illustrates how an 8-bit input sequence is processed through sequential functional blocks—collectively implementing convolutional encoding, symbol mapping, and SerDes-specific optimizations—to achieve coding gain and improved error performance in challenging high-speed SerDes in high-speed communication channels.

At a high level, the system depicted in FIG. 2 integrates a convolutional trellis logic 210 with a mapper 202. The convolutional trellis logic 210 introduces memory and redundancy for error correction, and the mapper 202 translates the partially encoded bits into PAM-modulated symbols according to a symbol alphabet 204 specific to high-speed SerDes, SerDes-specific rules 206, and SerDes specific transition groups 208. Together, these blocks ensure that the selected groups of PAM-modulated symbols meet performance requirements in the presence of insertion loss, noise, and/or inter-symbol interference characteristic of high-speed SerDes channels, as discussed below.

The convolutional trellis logic 210 is shown at the bottom of FIG. 2 and comprises: memory elements (e.g., D flip-flops) and logic gages (e.g., XOR gates). The memory elements (e.g., D flip-flops) store bits from previous encoding intervals, effectively maintaining a finite set of states (e.g., eight states) as stored state bits. The logic Gates (e.g., XOR) combine the current input bits with the stored state bits to produce new outputs and to update the trellis state. Convolutional trellis logic 210 uses two bits of the 8-bit input (a two-bit portion for instance, bits B6 and B7) to determine which new state the convolutional encoder 200 transitions to. The current or “source” state (stored in the flip-flops) and these two input bits define a next state among the finite set of allowable states.

Because the convolutional trellis logic 210 maintains memory across symbol intervals, it effectively spreads each bit's influence over multiple symbol transmissions. This structure introduces coding gain, enabling the receiver to correct errors through maximum likelihood sequence estimation or similar algorithms.

Mapper 202 is coupled to both the convolutional trellis logic 210 and the bits of the 8-bit input (B0-B7). Based on the current trellis state (or next state) and these additional bits, the mapper selects one of multiple valid groups of PAM-modulated symbols. Each group comprises four symbols (S0, S1, S2, S3) that exhibit a signal-level pattern. The mapper 202 references the symbol alphabet 204, SerDes-specific rules 206, and SerDes-specific transition groups 208 to determine which four-symbol pattern is both permissible and optimal under current channel conditions.

The symbol alphabet 204 is a predetermined symbol alphabet specific to high-speed SerDes. More specifically, symbol alphabet 204 includes a subset of a complete set of signal-level patterns considered valid for mapping digital data into physical signal levels. For PAM-modulated symbol groups, the full unconstrained set is the 625 possible combinations (since 5⁴=625 for a group of four symbols). The predetermined symbol alphabet 204 is a specific subset of these 625 combinations chosen to meet performance criteria of high-speed SerDes channels, as discussed herein.

The SerDes-specific rules 206 are logic constraints or lookup tables of rules that further refine which symbol groups can be selected for each transition. Because high-speed SerDes channels may exhibit varying levels of insertion loss or crosstalk, these rules can adapt or filter out certain symbol patterns. As non-limiting examples: disallowing transitions from −2 to +2 within a single group if the channel's DFE taps are large or enforcing a zero-mean DC condition.

Each transition group of the SerDes-specific transition groups 208 is a specific subset of groups of PAM-modulated symbols chosen and assigned for use with a specific trellis transition in the convolutional encoding process. In other words, while a “group of PAM-modulated symbols” refers to an ordered sequence of symbols (for example, a block of four PAM-modulated symbols that can represent up to 625 different signal-level patterns), a “predetermined transition group” is the set of such symbol groups that is allocated to a particular state transition within the trellis. For example, in one embodiment the 625 possible four-symbol combinations might be partitioned into several subsets, with each subset (each predetermined transition group) chosen to optimize performance metrics such as minimum Euclidean distance, DC balance, and resistance to DFE error propagation. These subsets are then used to encode the 6 bits of information associated with each trellis branch. Thus, the trellis organizes the encoding process into state transitions, and each transition is linked with one or more symbol groups. The chosen symbol group (i.e., the specific signal-level pattern) is what ultimately gets transmitted, ensuring that the mapping benefits from the error-correcting and performance-enhancing properties of the predetermined transition groups.

### Constraints for High DFE vs. Low DFE

In one or more examples, the mapping of PAM-modulated symbol groups to trellis transitions may be adapted to the operating environment, specifically to the magnitude of DFE activity. For channels characterized by low DFE tap magnitudes, a simpler mapping scheme may be employed. In such cases, symbol groups are assigned based primarily on ensuring adequate DC balance, achieving a minimum Euclidean distance between patterns, and maintaining low transmit power—without the need for extensive additional constraints. This “simplified” approach is sufficient in low DFE conditions because the risk of error propagation from DFE-related issues is minimal.

In contrast, for channels exhibiting high DFE tap magnitudes—where erroneous decisions in the DFE can lead to significant error propagation—a more sophisticated mapping strategy is beneficial. In these scenarios, the mapping algorithm incorporates additional constraints designed specifically to mitigate the adverse effects arising from DFE-induced errors. For instance, the algorithm may restrict allowable voltage transitions within a symbol group, explicitly avoiding large amplitude swings (such as direct transitions from −2 to +2), as these transitions increase susceptibility to DFE error propagation.

Additionally, certain examples utilize optimization techniques to select subsets of PAM-modulated symbol groups that enhance inter-pattern distance while simultaneously reducing susceptibility to DFE-induced errors. For example, in the context of high-speed SerDes communication and DFE, one type of problematic DFE-induced error pattern, referred to herein as “zig-zag patterns” or “zig-zag errors,” involves rapid, alternating symbol-level transitions between higher and lower amplitude levels, repeatedly (e.g., inter-symbol transitions such as . . . +1→−1→+1→−1 . . . or +2→−2→+2→−2). These patterns can exacerbate error propagation in DFE-based receivers, as the DFE relies on previously decided symbols to subtract inter-symbol interference (ISI). Once a symbol error occurs, the alternating high-magnitude transitions (“zig-zag”) amplify the likelihood that subsequent symbols will also be decoded incorrectly. Thus, zig-zag errors can significantly degrade receiver performance. Constraints and heuristic optimization techniques—such as simulated annealing, genetic algorithms, or other iterative search methodologies—may be used to identify subsets of symbol-level patterns having enhanced distance metrics and minimized susceptibility to zig-zag patterns. By assigning distinct symbol group subsets to particular state transitions of the convolutional trellis, the invention strategically isolates potential error conditions, thereby substantially reducing the likelihood and severity of zig-zag errors.

By tailoring the mapping to the specific DFE conditions, the examples discussed herein ensure that symbol groups are optimally selected to maintain robust performance, thereby enhancing coding gain and reducing the overall symbol error rate in high-speed SerDes channels.

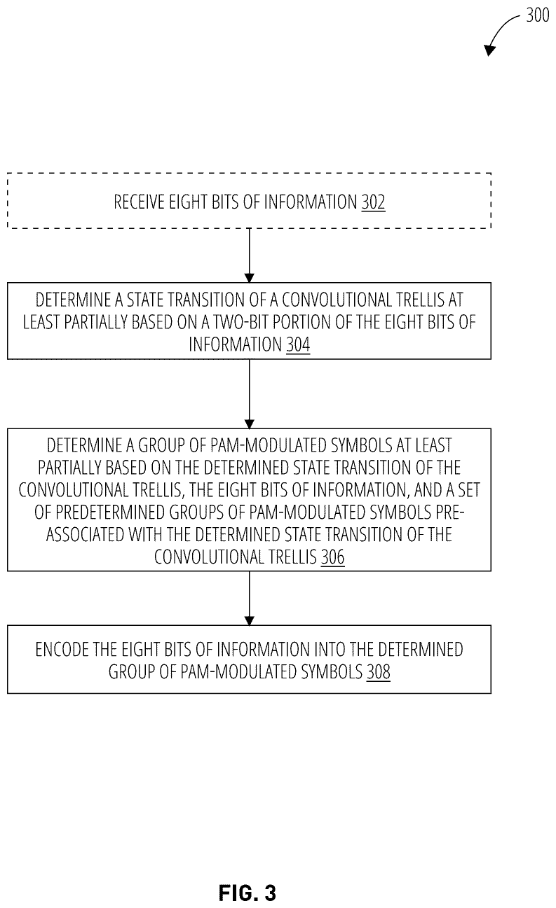

FIG. 3 illustrates an example process 300 for encoding an eight-bit input word into a group of PAM-modulated symbols using a convolutional trellis, in accordance with one or more examples. Although the example process 300 depicts a particular sequence of operations, the sequence may be altered without departing from the scope of the present disclosure. For example, some of the operations depicted may be performed in parallel or in a different sequence that does not materially affect the function of the process 300. In other examples, different components of an example device or system that implements the process 300 may perform functions at substantially the same time or in a specific sequence.

According to some examples, process 300 may include receiving eight bits of information at block 302.

According to some examples, process 300 may include determining a state transition of a convolutional trellis at least partially based on a two-bit portion of the eight bits of information at block 304. In one or more examples, the state transition may be determined at least partially based on information about the current state of the convolutional trellis (information about the current state stored at the convolutional trellis logic), and information about a next state of the convolutional trellis. The next state of the convolutional trellis may be determined based the information about the current state of the convolutional trellis and a portion of the eight bits of information that drives the next state transition at the convolutional trellis (e.g., a mapper (e.g., mapper 202, without limitation) may include logic to determine the next state of the convolutional trellis based on the portion of the eight bits of information that drives the next state transition at the convolutional trellis, without limitation). Convolutional encoding spreads each input bit's influence across multiple output symbols, providing redundancy that enhances error correction at the receiver. By partitioning the eight bits so that two bits define the next state, the encoder leverages a controlled state evolution.

According to some examples, process 300 may include determining a group of PAM-modulated symbols at least partially based on the determined state transition of the convolutional trellis, the eight bits of information, and a set of predetermined groups of PAM-modulated symbols pre-associated with the determined state transition of the convolutional trellis at block 306. The group of PAM-modulated symbols may also be determined at least partially based on information about the current state of the convolutional trellis (information about the current state stored at the convolutional trellis logic).

By choosing symbol groups that are pre-optimized for high-speed SerDes channels (e.g., ensuring minimum Euclidean distance and low error propagation), the system reduces symbol error rates and adapts to channel constraints like insertion loss or DFE behavior. As a non-limiting example, a lookup process uses the six bits as an index into a table of candidate PAM-modulated symbol groups associated with the selected trellis transition. Additional SerDes-specific rules (e.g., DC balance, maximum allowed level swings) may filter or refine the final choice. The chosen group (e.g., four voltage levels in the set {−2, −1, 0, +1, +2}) becomes the encoded representation of the input bits for this trellis branch.

According to some examples, the method includes encoding the eight bits of information into the determined group of PAM-modulated symbols at block 308. Four discrete amplitude values (S0, S1, S2, S3) our output each corresponding to one of five voltage levels.

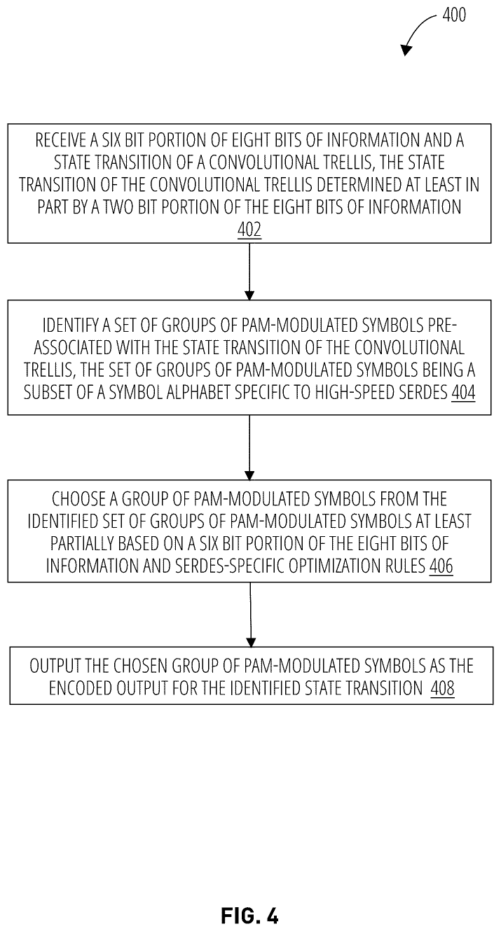

FIG. 4 illustrates an example process 400 to select a group of PAM-modulated symbols to represent eight bits of information, in accordance with one or more examples. Although the example process 400 depicts a particular sequence of operations, the sequence may be altered without departing from the scope of the present disclosure. For example, some of the operations depicted may be performed in parallel or in a different sequence that does not materially affect the function of the process 400. In other examples, different components of an example device or system that implements the process 400 may perform functions at substantially the same time or in a specific sequence.

According to some examples, process 100 may include receiving a six-bit portion of eight bits of information and a state transition of a convolutional trellis, the state transition of the convolutional trellis determined at least in part by a two-bit portion of the eight bits of information at block 402. The eight-bit word is split so that two bits define the trellis transition (and thus the next state), while the remaining six bits guide the choice of which PAM-modulated symbol group to use.

According to some examples, process 100 may include identifying a set of groups of PAM-modulated symbols pre-associated with the state transition of the convolutional trellis, the set of groups of PAM-modulated symbols being a subset of a symbol alphabet specific to high-speed SerDes at block 404. Constraining the symbol group choice to a limited, pre-optimized subset improves coding gain, ensures compatibility with SerDes constraints (e.g., DC balance, distance properties), and reduces error propagation.

According to some examples, process 100 may include choosing a group of PAM-modulated symbols from the identified set of groups of PAM-modulated symbols at least partially based on a six-bit portion of the eight bits of information and SerDes-specific optimization rules at block 406. Here, process 100 finalizes which exact 4-symbol PAM-modulated pattern (from the allowed subset) will represent the current encoding interval, ensuring that system constraints—such as minimal power, high Euclidean distance, or restricted large level swings—are met.

According to some examples, process 100 may include outputting the chosen group of PAM-modulated symbols as the encoded output for the identified state transition at block 408. This output corresponds to the actual physical-level symbols (four distinct PAM-modulated amplitude levels) that will be serialized and transmitted, effectively encoding the eight-bit word under the trellis-based scheme.

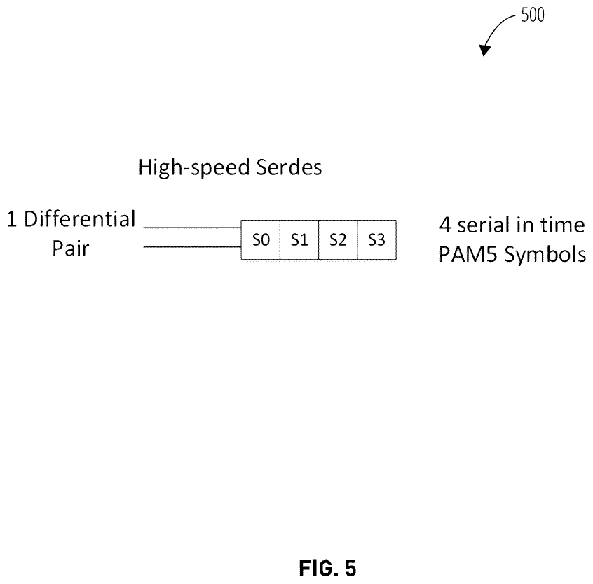

FIG. 5 is an example of four consecutive symbols S0, S1, S2 and S3 of a symbol group on differential pair of a high-speed SerDes.

For the SerDes example, there is a decision feedback element from S0 that infects S1. Since there is a DFE in here, there is a history on the differential pair. So, when determining the symbol group, consider that there is a single DFE tap connecting S0 to S1 and S1 to S2 and so on and so forth, all the way through the system.

If high DFE taps, use a completely different set of 512 and a different set of groupings than for low DFE taps.

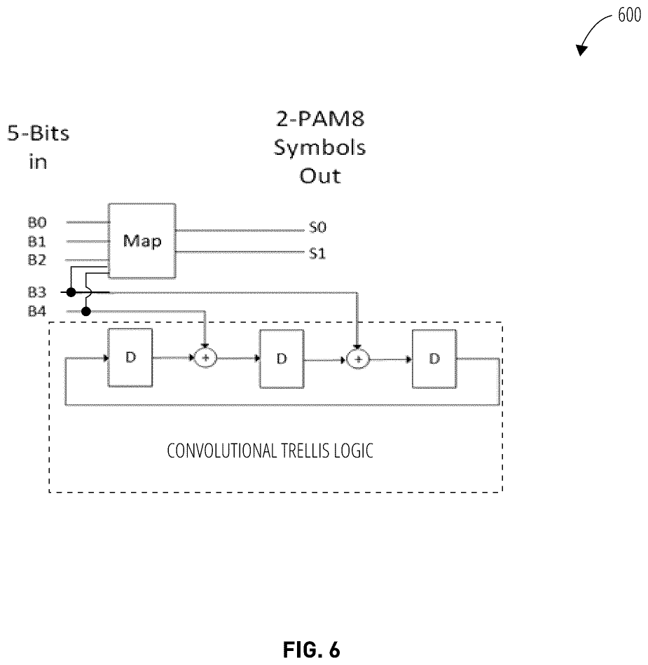

FIG. 6 is a block diagram depicting convolutional encoder 600 to implement a PAM8 modulation scheme, which may be utilized in high-speed SerDes systems, such as 448G applications, in accordance with one or more examples.

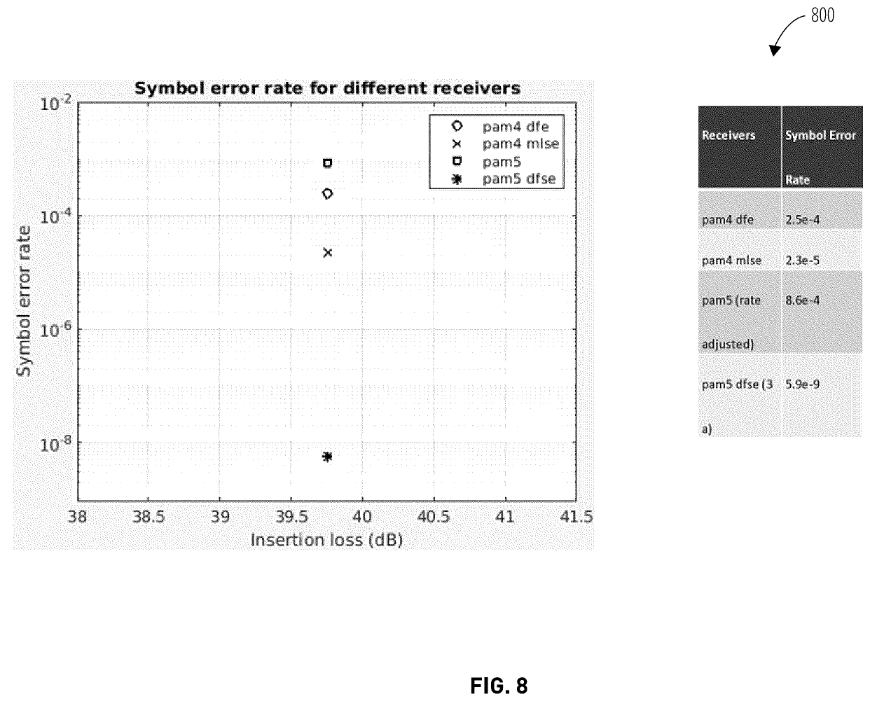

As shown in FIG. 8, the convolutional encoder receives a 5-bit input sequence (bits B0-B4). Bits B0, B1, B2, B3 and B4 are input directly into a mapper that also receives state information from convolutional trellis logic and based on those inputs produces two PAM8 symbols (S0 and S1). These symbols carry information and redundancy for robust data transmission. Bits B3 and B4 drive state transitions within the convolutional trellis logic, which comprises memory elements (e.g., flip-flops indicated by “D” blocks) and logic gates (such as XOR gates). These bits, combined with the stored states in the convolutional encoder, determine the state transitions and corresponding symbol patterns chosen from predetermined transition groups.

The convolutional trellis logic incorporates memory elements arranged sequentially, enabling it to store and recall previous encoding intervals, effectively creating memory of past inputs to influence the current encoding interval. This encoding method spreads information over multiple symbol intervals, enhancing error correction capabilities. In this example, eight different transition groups are defined, with each transition group including eight possible symbol patterns. Each transition between states of the encoder is uniquely associated with one of these transition groups, ensuring effective isolation of error propagation effects.

The PAM6 modulation approach illustrated here is particularly beneficial for 448G high-speed SerDes channels operating at approximately 89.6 GHz baud rates. PAM6 encoding inherently represents five bits of information using two symbols, whereas PAM8 encoding represents six bits in two symbols. Combining these modulation schemes within the convolutional trellis logic allows for a significant reduction in the symbol error rate (SER), improved coding gain, and enhanced resilience against channel impairments commonly observed in high-speed SerDes environments.

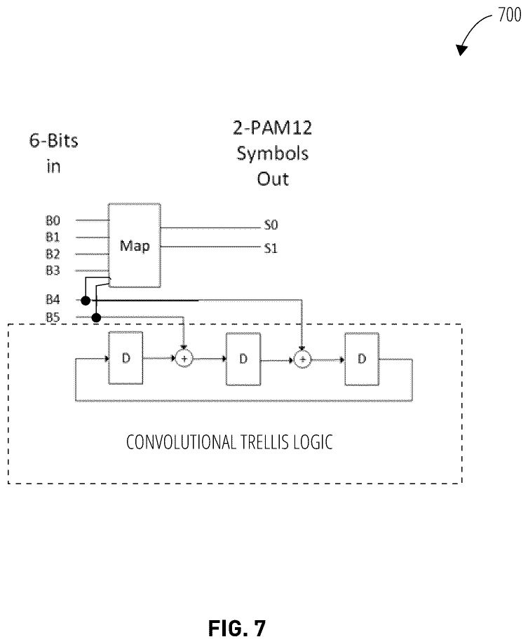

FIG. 7 depicts s a convolutional encoder 700 to implement PAM8 modulation, suitable for high-speed communication applications such as 448G SerDes links, in accordance with one or more examples. The depicted convolutional encoder receives an input of six bits of information and encodes these bits into a two-symbol PAM12 output suitable for transmission.

The convolutional encoder includes convolutional trellis logic comprising memory elements (e.g., D flip-flops) and summing elements (e.g., adders or XOR gates). Specifically, two bits of the six input bits (shown as bits B4 and B5) are provided to the convolutional trellis logic, which determines state transitions of the encoder. The trellis logic maintains a finite number of states—determined by the stored state bits within the memory elements—and transitions between these states based on the current input bits and previous state information. In this example, the convolutional coder employs a stateful encoding mechanism where each transition between states corresponds to specific arcs in a trellis representation, enabling redundancy and memory across multiple symbol intervals for improved error correction capabilities.

The mapper receives all six input bits (shown as bits B0-B5) in conjunction with state information from the convolutional trellis logic. Using this combination of input bits and state information, the mapper chooses appropriate PAM12 symbols (S0 and S1) from predetermined sets of groups of PAM12 symbols optimized for channel characteristics and coding performance. PAM12 modulation involves symbols with twelve distinct signal amplitude levels. Each symbol can thus encode a higher number of bits compared to traditional PAM schemes, enabling efficient use of available signal space.

In this specific non-limiting encoder configuration, two PAM12 symbols are generated per encoding operation, resulting in 144 possible signal-level patterns (12×12). However, only 128 of these signal-level patterns are required for encoding 7 bits of information. Consequently, 16 of the available patterns remain unused, providing additional flexibility for optimization and coding gain.

The convolutional encoder further organizes the signal-level patterns into eight distinct transition groups, each consisting of 16 possibilities. Each transition group is assigned to specific state transitions within the convolutional trellis logic, providing optimal characteristics for performance parameters such as Euclidean distance, resistance to decision feedback equalizer (DFE) induced errors, and reduced susceptibility to channel impairments such as insertion loss, noise, and inter-symbol interference (ISI).

This convolutional encoder, leveraging state memory, optimized mapping, and PAM12 symbols, allows for enhanced performance suitable for high-speed SerDes applications, enabling reliable transmission at baud rates approaching or exceeding 74.66 GHz.

FIG. 8 a graph depicting non-limiting example comparative performance analysis of different pulse amplitude modulation (PAM) encoding techniques and receiver structures, specifically highlighting the effectiveness of the disclosed convolutional trellis encoding and optimized symbol selection techniques discussed herein for PAM-modulated signals in high-speed SerDes applications. The graph depicts symbol error rate (SER) performance as a function of insertion loss (measured in dB), comparing standard PAM4 and PAM5 modulation schemes, and various receiver equalization algorithms, including decision feedback equalization (DFE), maximal likelihood sequence estimation (MLSE), and decision feedback sequence estimation (DFSE).

As shown, the performance of four distinct configurations is represented: a standard PAM4 modulation scheme employing DFE (marked by diamond-shaped symbols), a standard PAM4 modulation employing MLSE (marked by cross-shaped symbols), a standard PAM5 modulation scheme with an adjusted baud rate employing conventional receiver processing (square-shaped symbols), and a PAM5 modulation scheme employing DFSE, according to the present invention (star-shaped symbols).

Notably, the graph demonstrates that, in this specific non-limiting example, the PAM5 modulation combined with DFSE outperformed traditional PAM4 and PAM5 implementations. For instance, at an insertion loss of approximately 39.5 dB, standard PAM4modulation with DFE exhibits an SER of about 2.5×10⁻⁴, and PAM4 modulation with MLSE achieves approximately 2.3×10⁻⁵. Standard PAM5 modulation (with adjusted baud rate) yields approximately 8.6×10⁻⁴, whereas the PAM5 modulation employing the DFSE approach as described herein achieves a significantly lower SER of approximately 5.9×10⁻⁹.

These empirical results validate that applying convolutional trellis encoding in combination with optimized PAM modulation symbol selection discussed herein—particularly, in this non-limiting example, suited to mitigate DFE-induced errors and inter-symbol interference—yields a substantial improvement in symbol detection accuracy and robustness for high-loss channels typical of high-speed SerDes environments. Thus, the disclosed approach advantageously addresses stringent error rate requirements and channel impairments characteristic of advanced high-speed communication systems.

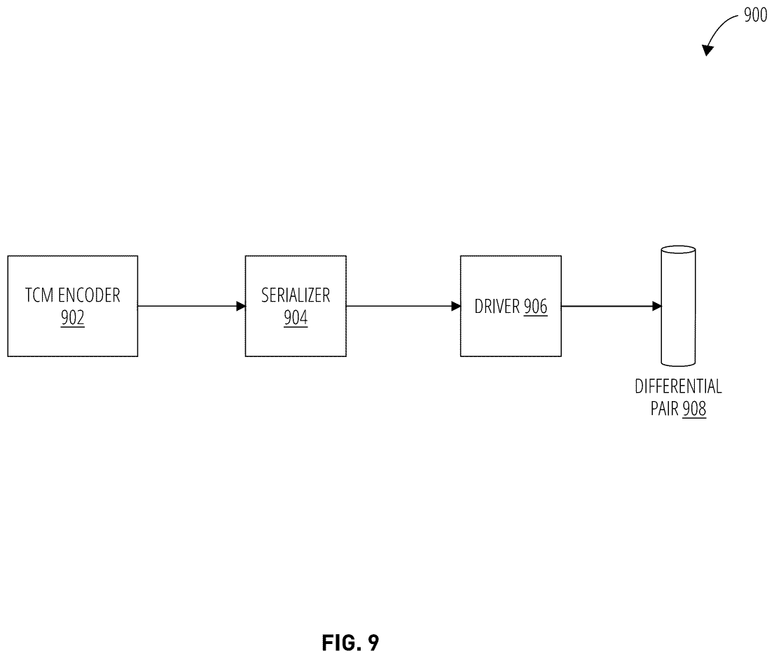

FIG. 9 is a block diagram depicting a system (or apparatus) 900 for high-speed data transmission in accordance with one or more examples. System 900 includes a TCM encoder 902, a serializer 904, and a driver 906 coupled to a differential pair 908. Collectively, the TCM encoder 902, serializer 904, and driver 906 form a high-speed SerDes transmitter capable of efficiently encoding and sending data over differential pair 908 under challenging channel conditions. By employing the optimized PAM-modulated symbol mapping and trellis-coded modulation discussed herein, system 900 is capable of improved error performance and reduced power consumption relative to conventional solutions.

TCM encoder 902 receives input data (e.g., an 8-bit word or other format) and applies a trellis-coded modulation scheme (TCM) to produce PAM-modulated symbols. This may involve referencing a symbol alphabet tailored for high-speed SerDes channels, as well as applying convolutional coding to improve error resilience.

TCM encoder 902 implements the mapping bits to PAM-modulated symbol groups, optionally leveraging transition groups, DFE-aware constraints, or other channel-optimized strategies discussed herein, in accordance with one or more examples.

Serializer 904 converts the parallel output from the TCM encoder 902 into a high-speed serial data stream. By shifting or multiplexing the PAM-modulated symbols out at a rapid clock rate, the serializer 904 ensures compatibility with high-speed SerDes link requirements.

While the serializer 904 may be of a traditional design, it operates in tandem with the TCM encoder's unique symbol mapping to deliver precisely timed symbol sequences onto the physical link.

Driver 906 conditions the serialized PAM-modulated data for transmission. It may include output buffers, pre-emphasis or de-emphasis circuitry, and impedance matching elements to mitigate signal loss, reflections, and noise in high-speed channels.

By driving the signal at an appropriate amplitude and waveform shape, the driver 906 ensures that the carefully selected PAM-modulated symbols are faithfully conveyed across the differential pair 908.

Differential pair 908 provides the physical medium (e.g., twisted pair or PCB traces) over which the high-speed PAM-modulated encoded data is transmitted. Operating differentially helps reject common-mode noise and reduce electromagnetic interference. Differential pair 908 carries the TCM-encoded PAM-modulated symbols to the receiver. The encoding and symbol selection strategies are specifically designed to address the impairments (e.g., insertion loss, ISI, DFE error propagation) encountered along this medium.

Examples described herein may utilize various PAM modulation schemes (e.g., PAM4, PAM5, PAM6, PAM8, without limitation) and further include PAM variants such as a specific modulation, mapping, or encoding variant devised to address channel-specific impairments (e.g., special symbol mapping, convolutional coding (CC), or LDPC coding, without limitation) and performance objectives.

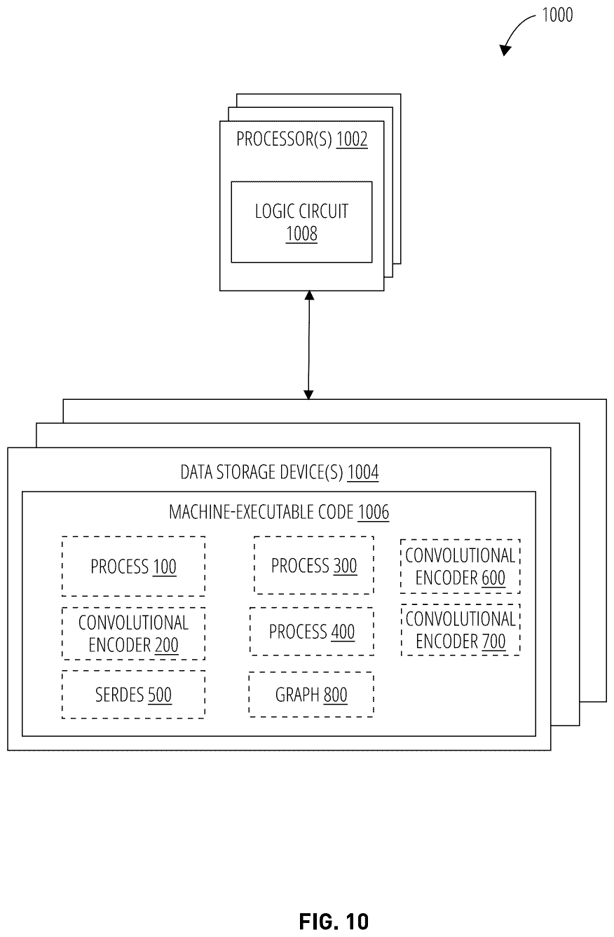

It will be appreciated by those of ordinary skill in the art that functional elements of examples disclosed herein (e.g., functions, operations, acts, processes, or methods) may be implemented in any suitable hardware, software, firmware, or combinations thereof. FIG. 10 illustrates non-limiting examples of implementations of functional elements disclosed herein. In some examples, some or all portions of the functional elements disclosed herein may be performed by hardware capable of carrying out the functional elements.

FIG. 10 is a block diagram of a circuitry 1000 that, in some examples, may be used to implement various functions, operations, acts, processes, or methods disclosed herein. The circuitry 1000 includes one or more processors 1002 (sometimes referred to herein as “processors 1002”) operably coupled to one or more data storage devices 1004 (sometimes referred to herein as “storage 1004”). The storage 1004 includes machine-executable code 1006 stored thereon and the processors 1002 include logic circuit 1008. The machine-executable code 1006 information describing functional elements that may be implemented by (e.g., performed by) the logic circuit 1008. The logic circuit 1008 is adapted to implement (e.g., perform) the functional elements described by the machine-executable code 1006. The circuitry 1000, when executing the functional elements described by the machine-executable code 1006, should be considered as special purpose hardware for carrying out functional elements disclosed herein. In some examples the processors 1002 may perform the functional elements described by the machine-executable code 1006 sequentially, concurrently (e.g., on one or more different hardware platforms), or in one or more parallel process streams.

When implemented by logic circuit 1008 of the processors 1002, the machine-executable code 1006 adapts the processors 1002 to perform operations of examples disclosed herein. By way of non-limiting example, the machine-executable code 1006 may adapt the processors 1002 to perform some or a totality of operations of process 100, process 300, process 400, SerDes 500, or graph 800.

Also, by way of non-limiting example, the machine-executable code 1006 may adapt the processors 1002 to perform some or a totality of features, functions, or operations disclosed herein. More specifically, features, functions, or operations disclosed herein for one or more of: convolutional encoder 200, convolutional encoder 600, convolutional encoder 700 or system 900.

The processors 1002 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1006 (e.g., software code, firmware code, hardware descriptions) related to examples of the present disclosure. It is noted that a general-purpose processor (may also be referred to herein as a host processor or simply a host) may be a microprocessor, but in the alternative, the processors 1002 may include any conventional processor, controller, microcontroller, or state machine. The processors 1002 may also be implemented as a combination of computing devices, such as a combination of a DSP and a microprocessor, a plurality of microprocessors, one or more microprocessors in conjunction with a DSP core, or any other such configuration.

In some examples the storage 1004 includes volatile data storage (e.g., random-access memory (RAM)), non-volatile data storage (e.g., Flash memory, a hard disc drive, a solid-state drive, erasable programmable read-only memory (EPROM), without limitation). In some examples the processors 1002 and the storage 1004 may be implemented into a single device (e.g., a semiconductor device product, a system on chip (SOC), without limitation). In some examples the processors 1002 and the storage 1004 may be implemented into separate devices.

In some examples the machine-executable code 1006 may include computer-readable instructions (e.g., software code, firmware code). By way of non-limiting example, the computer-readable instructions may be stored by the storage 1004, accessed directly by the processors 1002, and executed by the processors 1002 using at least the logic circuit 1008. Also by way of non-limiting example, the computer-readable instructions may be stored on the storage 1004, transferred to a memory device (not shown) for execution, and executed by the processors 1002 using at least the logic circuit 1008. Accordingly, in some examples the logic circuit 1008 includes electrically configurable logic circuit 1008.

In some examples the machine-executable code 1006 may describe hardware (e.g., circuitry) to be implemented in the logic circuit 1008 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog or very large-scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1008 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1006 may include an HDL, an RTL, a GL description, a mask level description, other hardware description, or any combination thereof.

In examples where the machine-executable code 1006 includes a hardware description (at any level of abstraction), a system (not shown, but including the storage 1004) implements the hardware description described by the machine-executable code 1006. By way of non-limiting example, the processors 1002 may include a programmable logic device (e.g., an FPGA or a PLC) and the logic circuit 1008 may be electrically controlled to implement circuitry corresponding to the hardware description into the logic circuit 1008. Also by way of non-limiting example, the logic circuit 1008 may include hard-wired logic manufactured by a manufacturing system (not shown, but including the storage 1004) according to the hardware description of the machine-executable code 1006.

Regardless of whether the machine-executable code 1006 includes computer-readable instructions or a hardware description, the logic circuit 1008 is adapted to perform the functional elements described by the machine-executable code 1006 when implementing the functional elements of the machine-executable code 1006. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: An apparatus, comprising: a mapper to encode eight bits of information into a group of PAM-modulated symbols, a signal-level pattern of the group of PAM-modulated symbols at least partially based on a predetermined symbol alphabet specific to high-speed SerDes; a serializer to convert the group of PAM-modulated symbols into serialized form; and a driver to physically transmit the serialized group of PAM-modulated symbols on a differential pair.

Example 2: The apparatus according to Example 1, wherein the predetermined symbol alphabet specific to high-speed SerDes includes a set of signal-level patterns for mapping digital data into physical signal levels, wherein the set of signal-level patterns is a subset of a complete set of signal-level patterns considered valid for mapping digital data into physical signal levels.

Example 3: The apparatus according to any of Examples 1 and 2, wherein respective signal-level patterns of the subset are chosen at least partially based on channel characteristics specific to high-speed SerDes.

Example 4: The apparatus according to any of Examples 1 through 3, wherein respective signal-level patterns of the subset are chosen at least partially based on one or more performance metrics that quantify how well a signal-level pattern tolerates or mitigates effects of adverse ones of the channel characteristics specific to high-speed SerDes, wherein the one or more performance metrics include one or more of: minimum Euclidean distance, DC balance, or power consumption.

Example 5: The apparatus according to any of Examples 1 through 4, wherein the adverse ones of the channel characteristics specific to high-speed SerDes include one or more of: insertion loss, inter-symbol interference, or decision feedback equalizer (DFE) behavior.

Example 6: The apparatus according to any of Examples 1 through 5, wherein the respective signal-level patterns of the subset are chosen to maximize a distance between the respective ones of the signal-level patterns of the subset and reduce a number of level swings that induce error through DFE propagation.

Example 7: The apparatus according to any of Examples 1 through 6, wherein the mapper comprises: a finite-state machine represented as a convolutional trellis, the convolutional trellis to distribute information of an input bit sequence over multiple groups of PAM-modulated symbols, the multiple groups of PAM-modulated symbols respectively of the predetermined symbol alphabet specific to high-speed SerDes.

Example 8: The apparatus according to any of Examples 1 through 7, wherein the convolutional trellis defines a set of states and a set of allowable transitions between the states, and wherein ones of the allowable transitions between the states are respectively associated with respective ones of the multiple groups of PAM-modulated symbols.

Example 9: The apparatus according to any of Examples 1 through 8, wherein the mapper to: determine state transition of a convolutional trellis at least partially based on a two-bit portion of the eight bits of information; and determine groups of PAM-modulated symbols at least partially based on the determined state transitions of the convolutional trellis, the eight bits of information, and a set of predetermined groups of PAM-modulated symbols pre-associated with the determined state transition of the convolutional trellis, wherein the two-bit portion of the eight bits of information and the eight bits of information correspond to different distinct bits of the eight bits of information.

Example 10: The apparatus according to any of Examples 1 through 9, wherein the predetermined groups of PAM-modulated symbols are a subset of the symbol groups of the symbol alphabet.

Example 11: The apparatus according to any of Examples 1 through 10, wherein a set of 4 transition groups of at least 8 predetermined transition groups is associated with transitions from even states of the convolutional trellis, and a different set of 4 transitions groups of the at least 8 predetermined transition groups is associated with transitions from odd states of the convolutional trellis.

Example 12: The apparatus according to any of Examples 1 through 11, wherein the symbol alphabet specific to high-speed SerDes is at least partially based on a single decision feedback equalization tap.

Example 13: A method, comprising: receiving eight bits of information; determining a state transition of a convolutional trellis at least partially based on a two-bit portion of the eight bits of information; determining a group of PAM-modulated symbols at least partially based on the determined state transition of the convolutional trellis, the eight bits of information, and a set of predetermined groups of PAM-modulated symbols pre-associated with the determined state transition of the convolutional trellis; and encoding the eight bits of information into the determined group of PAM-modulated symbols.

Example 14: A method, comprising: generating a complete set of candidate signal-level patterns, each corresponding to a group of PAM-modulated symbols; applying one or more constraints to filter out candidate signal-level patterns that do not meet predefined performance requirements for a high-speed SerDes environment, resulting in a filtered set of candidate signal-level patterns; using an optimization technique to evaluate the filtered set of candidate signal-level patterns against a cost function that aggregates one or more performance metrics; and selecting, based on the evaluation, a subset of the filtered set of candidate signal-level patterns as a symbol alphabet for mapping digital data into physical signal levels.

Example 15: The method according to Example 14, comprising partitioning the selected subset of candidate signal-level patterns into a plurality of transition groups, each transition group being associated with a respective state transition of a convolutional trellis.

Example 16: The method according to any of Examples 14 and 15, comprising outputting the symbol alphabet, including the transition groups, for subsequent use by a trellis-coded modulation encoder in the high-speed SerDes environment.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus, comprising:
a mapper to encode eight bits of information into a group of PAM-modulated symbols, a signal-level pattern of the group of PAM-modulated symbols at least partially based on a predetermined symbol alphabet specific to high-speed SerDes;
a serializer to convert the group of PAM-modulated symbols into serialized form; and
a driver to physically transmit the serialized group of PAM-modulated symbols on a differential pair.

2. The apparatus of claim 1, wherein the predetermined symbol alphabet specific to high-speed SerDes includes a set of signal-level patterns for mapping digital data into physical signal levels, wherein the set of signal-level patterns is a subset of a complete set of signal-level patterns considered valid for mapping digital data into physical signal levels.

3. The apparatus of claim 2, wherein respective signal-level patterns of the subset are chosen at least partially based on channel characteristics specific to high-speed SerDes.

4. The apparatus of claim 3, wherein respective signal-level patterns of the subset are chosen at least partially based on one or more performance metrics that quantify how well a signal-level pattern tolerates or mitigates effects of adverse ones of the channel characteristics specific to high-speed SerDes, wherein the one or more performance metrics include one or more of: minimum Euclidean distance, DC balance, or power consumption.

5. The apparatus of claim 4, wherein the adverse ones of the channel characteristics specific to high-speed SerDes include one or more of: insertion loss, inter-symbol interference, or decision feedback equalizer (DFE) behavior.

6. The apparatus of claim 5, wherein the respective signal-level patterns of the subset are chosen to maximize a distance between the respective ones of the signal-level patterns of the subset and reduce a number of level swings that induce error through DFE propagation.

7. The apparatus of claim 1, wherein the mapper comprises:
a finite-state machine represented as a convolutional trellis, the convolutional trellis to distribute information of an input bit sequence over multiple groups of PAM-modulated symbols, the multiple groups of PAM-modulated symbols respectively of the predetermined symbol alphabet specific to high-speed SerDes.

8. The apparatus of claim 7, wherein the convolutional trellis defines a set of states and a set of allowable transitions between the states, and wherein ones of the allowable transitions between the states are respectively associated with respective ones of the multiple groups of PAM-modulated symbols.

9. The apparatus of claim 1, wherein the mapper to:
determine state transition of a convolutional trellis at least partially based on a two-bit portion of the eight bits of information; and
determine groups of PAM-modulated symbols at least partially based on the determined state transitions of the convolutional trellis, the eight bits of information, and a set of predetermined groups of PAM-modulated symbols pre-associated with the determined state transition of the convolutional trellis,
wherein the two-bit portion of the eight bits of information and the eight bits of information correspond to different distinct bits of the eight bits of information.

10. The apparatus of claim 9, wherein the predetermined groups of PAM-modulated symbols are a subset of the symbol groups of the symbol alphabet.

11. The apparatus of claim 9, wherein a set of 4 transition groups of at least 8 predetermined transition groups is associated with transitions from even states of the convolutional trellis, and a different set of 4 transitions groups of the at least 8 predetermined transition groups is associated with transitions from odd states of the convolutional trellis.

12. The apparatus of claim 1, wherein the symbol alphabet specific to high-speed SerDes is at least partially based on a single decision feedback equalization tap.

13. A method, comprising:
receiving eight bits of information;
determining a state transition of a convolutional trellis at least partially based on a two-bit portion of the eight bits of information;
determining a group of PAM-modulated symbols at least partially based on the determined state transition of the convolutional trellis, the eight bits of information, and a set of predetermined groups of PAM-modulated symbols pre-associated with the determined state transition of the convolutional trellis; and
encoding the eight bits of information into the determined group of PAM-modulated symbols.

14. A method, comprising:
generating a complete set of candidate signal-level patterns, each corresponding to a group of PAM-modulated symbols;
applying one or more constraints to filter out candidate signal-level patterns that do not meet predefined performance requirements for a high-speed SerDes environment, resulting in a filtered set of candidate signal-level patterns;
using an optimization technique to evaluate the filtered set of candidate signal-level patterns against a cost function that aggregates one or more performance metrics; and
selecting, based on the evaluation, a subset of the filtered set of candidate signal-level patterns as a symbol alphabet for mapping digital data into physical signal levels.

15. The method of claim 14, comprising partitioning the selected subset of candidate signal-level patterns into a plurality of transition groups, each transition group being associated with a respective state transition of a convolutional trellis.

16. The method of claim 15, comprising outputting the symbol alphabet, including the transition groups, for subsequent use by a trellis-coded modulation encoder in the high-speed SerDes environment.
